(19) United States
(12) Patent Application Publication
(10) Pub. No.: US 2006/0019683 A1
(43) Pub. Date: Jan. 26, 2006

(54) Method of transmitting pictures by mobile telecommunication device

(75) Inventors: Cheng-Shing Lai, Taipei Hsien (TW); Wan-Jun Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,944

(22) Filed: Jul. 20, 2004

(51) Int. Cl. H04B 1/18; H04Q 7/20; H04M 1/00; H04B 1/38

(52) U.S. Cl. 455/466; 455/566

(57) ABSTRACT

The present invention discloses a method of transmitting pictures by a mobile telecommunication device through a picture specification conversion program installed in the mobile telecommunication device, and by using the picture specification conversion table to convert the specification of a picture information into the size complying with the display screen of a model number of a receiver's mobile telecommunication device, enabling the display screen of the receiver's mobile telecommunication device to fully show the pictures in the picture information.

### BACKGROUND OF THE INVENTION

1. Field of the Invention

The present invention relates to a method of transmitting pictures, more particularly to a method of transmitting pictures by a mobile telecommunication device through a picture specification conversion program installed in the mobile telecommunication device, and by using the picture specification conversion table to convert the specification of a picture information into the size complying with the display screen of a model number of a receiver's mobile telecommunication device, enabling the display screen of the receiver's mobile telecommunication device to fully show the pictures in the picture information.

2. Description of the Related Art

After the General Packet Radio Service (GPRS) technology was established, the GPRS technology integrates the independent Global System for Mobile Communication (GSM) and Internet and also adds several data exchange nodes to the current Global System for Mobile Communication. Since the data exchange node has the function of processing packets, so that the Global System for Mobile Communication can be connected to the Internet.

Further, the maximum transmission rate between a handset incorporating the General Packet Radio Service technology (hereinafter referred to as GPRS handset) and a base station reaches 160 Kbps, and the data transmission rate of a handset incorporating the Global System for Mobile System (GSM) technology (hereinafter referred to as GSM handset) is 9.6 Kbps. Thus, the transmission rate of the GPRS handset is about 16˜17 times faster than that of the GSM handset, which is a large increase. The speed 160 Kbps is also 2˜3 times faster than the dialup modem speed 56 Kbps. General personal computers can use the transmission rate of 56 Kbps to browse the text and graphics on Internet. Of course, the GPRS handset can concurrently send out multimedia information including sound, pictures and text. For example, a GPRS handset is used to send multimedia messaging service (MMS), and MMS is called “Color Information” by China Mobile Company or “Color Mobile Audio and Picture Message Service” by Taiwan Mobitai Communications. As implied by its name, multimedia messaging service (MMS) can transmit contents of multimedia information including various text information, black and white or color graphic files, sound (including ring tone, chord ring, a record of sound, or even a use's voice recorded by the handset and differs according to different supporting file formats). Besides transmitting rich contents, the MMS also inherits the advantages of the traditional short message for sending multimedia short messages to opposite parties or receiving multimedia short messages from one's handset or email address. Compared with the short message service (SMS), MMS can transmit larger volume of information in a richer and more colorful expression form.

However, since the size of display screen of the GPRS handset of each brand or different models of the same brand is different. If a GPRS handset uses MMS to directly send out pictures without making any editing, the receiver's handset may have the following problems when displaying the received pictures:

(1) The size of the pictures sent by the sender's handset is larger than the size of display screen of the receiver's handset. As a result, the edge of the picture goes beyond the edge of the display screen, and the receiver's handset cannot show the picture in full.

(2) The size of the pictures sent by the sender's handset is smaller than the size of display screen of the receiver's handset. As a result, some dark edges are produced between the edge of the display screen and the edge of the picture.

Therefore, fully showing a picture transmitted from a sender's handset onto the display screen of a receiver's handset demands immediate attention and solution.

### SUMMARY OF THE INVENTION

In view of the shortcomings of the prior art, the inventor of the present invention conducted extensive researches and experiments, and developed a method of transmitting pictures through a mobile telecommunication device in accordance with the invention.

The primary objective of the present invention is to provide a method that installs a picture specification conversion program in a mobile telecommunication device, and the picture specification conversion program includes a picture display conversion table, and the picture display conversion table includes a plurality of fields for inputting model numbers of different mobile telecommunication device and picture specifications corresponding to the model numbers, so that when the mobile telecommunication device sends a picture information to a receiver's mobile telecommunication device, the mobile telecommunication device uses the picture specification conversion table to obtain the picture specification of the receiver's mobile telecommunication device, and then converts the specification of the picture information into the size complying with the display screen of the receiver's mobile telecommunication device, and sends the converted picture information out. Therefore, the display screen of the receiver's mobile telecommunication device can fully show the pictures in the converted picture information.

The above and other objects, features and advantages of the present invention will become apparent from the following detailed description taken with the accompanying drawings.

### BRIEF DESCRIPTION OF THE DRAWINGS

FIG. 1 is a schematic block diagram of the structure of the present invention.

FIG. 2 is a schematic diagram of the picture display conversion table according to the present invention.

FIG. 3 is a schematic diagram of the screen of a mobile telecommunication device editing the phone book according to the present invention.

FIG. 4 is a flow chart of a mobile telecommunication device editing the phone book according to the present invention.

FIG. 5 is a flow chart of a mobile telecommunication device editing the picture display conversion table according to the present invention.

FIG. 6 is a flow chart of a mobile telecommunication device transmitting a picture information according to the present invention.

### DETAILED DESCRIPTION OF THE PREFERRED EMBODIMENTS

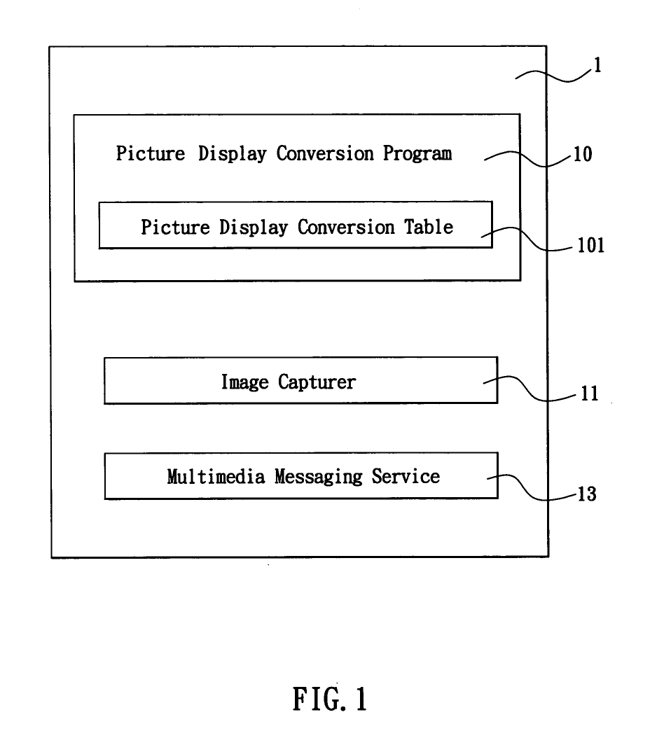

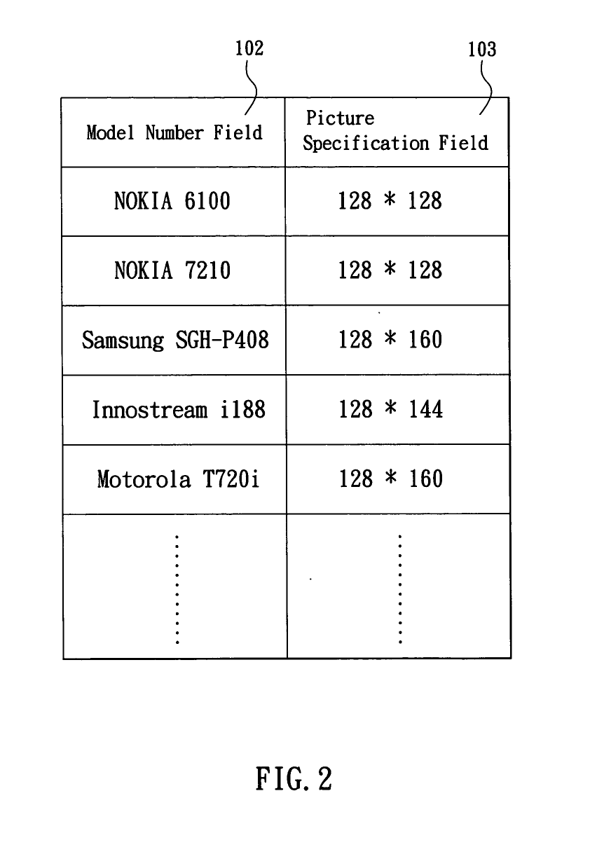

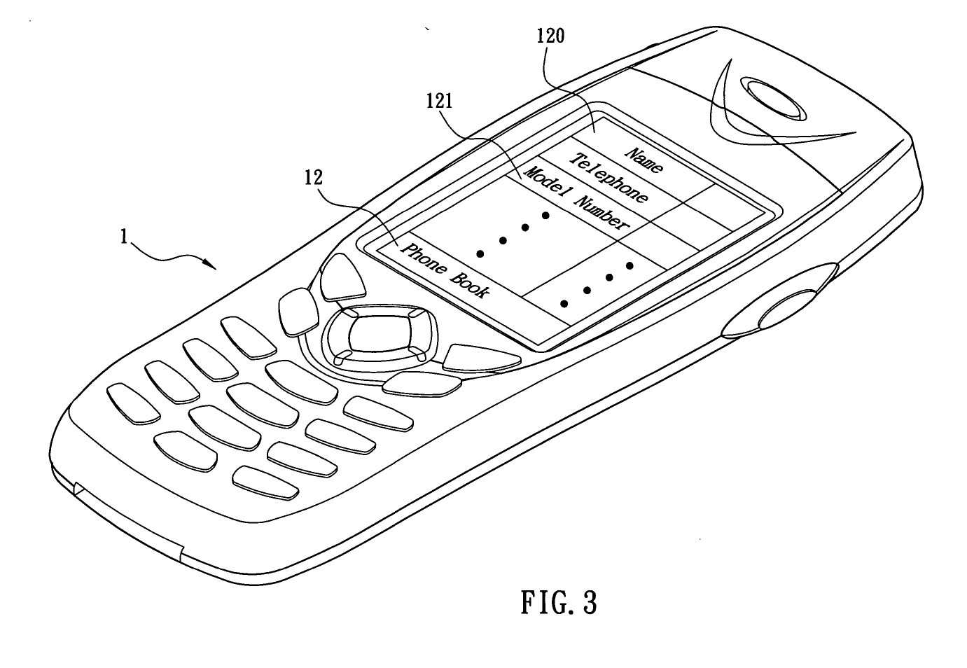

Please refer to FIGS. 1 and 2 for a method of transmitting pictures by a mobile telecommunication device according to the present invention. In the figures, the mobile telecommunication device 1 is installed with a picture specification conversion program 10, and the picture specification conversion program 10 includes a picture display conversion table 101 having a plurality of model number fields 102 and a plurality of picture specification fields 103 corresponding to the model number fields 102. Each of the model number fields 102 is inputted with a specific model number and each of the picture specification fields 103 is inputted with a specific picture specification corresponding to the model number. Further, a model number setup field 121 is added into each number record 120 of a phone book 12 of the mobile telecommunication device 1 for the user to input a model number of a receiver's mobile telecommunication device or to select the same from the picture display conversion table 101 (as shown in FIG. 3), such that when the mobile telecommunication device 1 is going to transmit a picture information to a receiver's mobile telecommunication device, the mobile telecommunication device uses the picture conversion program 10 to obtain the model number of the receiver's mobile telecommunication device from the model number setup field 121 according to the telephone number (or the receiver's name) of the receiver's mobile telecommunication device being inputted, and uses the model number to obtain the corresponding picture specification of the display screen of the receiver's mobile telecommunication device from the picture display conversion table 101, and then converts the specification of the picture information being sent into the picture specification of the display screen of the receiver's mobile telecommunication device, and sends the converted picture information out. This method allows the picture information received by the receiver's mobile telecommunication device to be completely displayed on the display screen of the receiver's mobile telecommunication device.

The mobile telecommunication device 1 according to a preferred embodiment of the present invention is a handset or a personal digital assistant that comprises an image capturer 11 and a multimedia messaging service 13, such that the mobile telecommunication device 1 can use the image capturer 11 to obtain a picture or be connected with an electronic device (such as a computer or a network server) to download pictures, and use the multimedia messaging service 13 to edit the picture into a picture information. If it is necessary to transmit the picture information, the picture specification program 10 is used to obtain the model number of the receiver's mobile telecommunication device from the corresponding number record 120 of the phone book 12 according to the receiver's telephone number (or name), and also obtain the picture specification from the picture display conversion table 101 according to the model number of the receiver's mobile telecommunication device, and then convert the specification of the picture information into the size complying with the display screen of the receiver's mobile telecommunication device and send the converted picture information out.

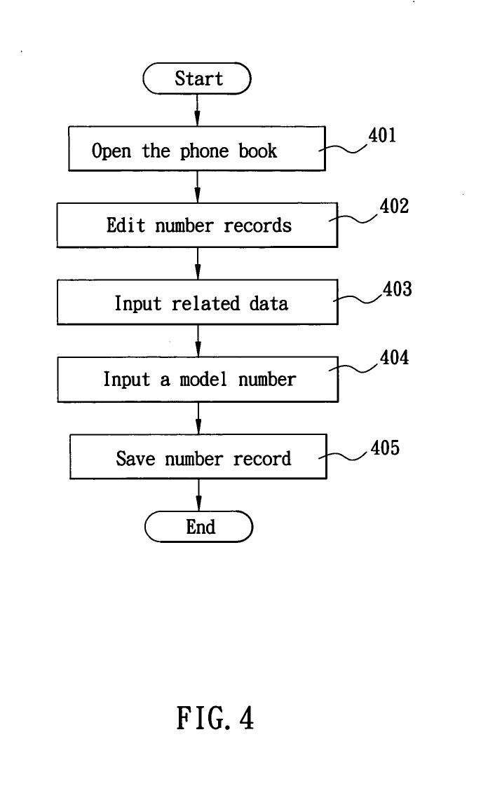

Please refer to FIG. 4 for a preferred embodiment of the present invention. The content of the phone book 12 of the mobile telecommunication device 1 can be edited according to the following steps:

(401) Start the mobile telecommunication device 1 and open the phone book 12.

(402) Edit a number record 120 in the phone book 12 for adding or modifying the data relating to a receiver's name and telephone number.

(403) Input the data relating to the receiver into the corresponding field of the number record 120.

(404) Input a model number of the receiver's mobile telecommunication device into the model number setup field 121 of the number record 120.

(405) Save the newly added or modified number record 120 in the phone book 12. Therefore, the model number of the receiver's mobile telecommunication device is now saved in the model number setup field 121 of the number record 120 of the phone book 12, such that if a mobile telecommunication device 1 sends a picture information to a receiver's mobile telecommunication device, the picture specification thereof will be converted, according to the picture display conversion table 101, into the size exactly complying with the display screen of the receiver's mobile telecommunication device.

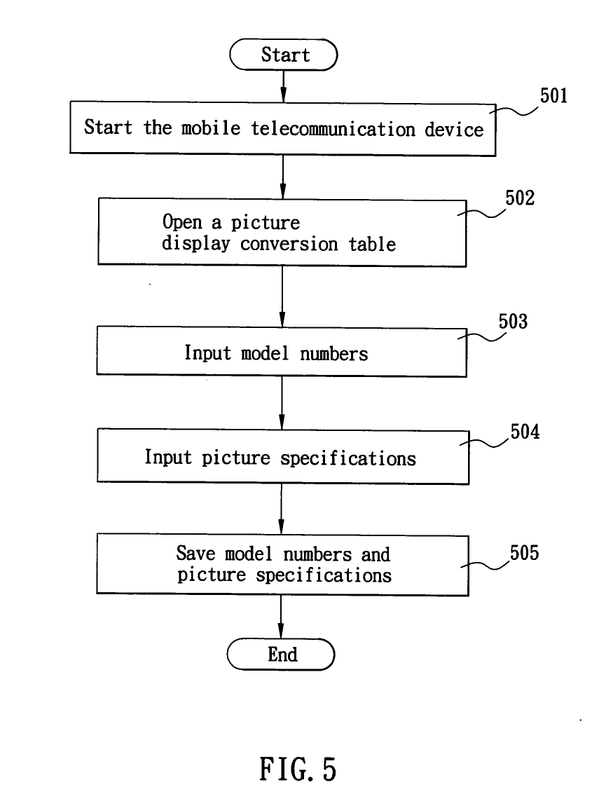

Please refer to FIG. 5, the content of the picture display conversion table 101 of the mobile telecommunication device 1 can be edited according to the following steps:

(501) Start the mobile telecommunication device 1.

(502) Open the picture display conversion table 101.

(503) Edit the picture display conversion table 101 for adding or modifying the model numbers of different mobile telecommunication devices.

(504) Edit the picture display conversion table 101 for adding or modifying the picture specifications corresponding to the model numbers of different mobile telecommunication devices.

(505) Save the newly added or modified model numbers and picture specifications of the different mobile telecommunication devices in the picture display conversion table.

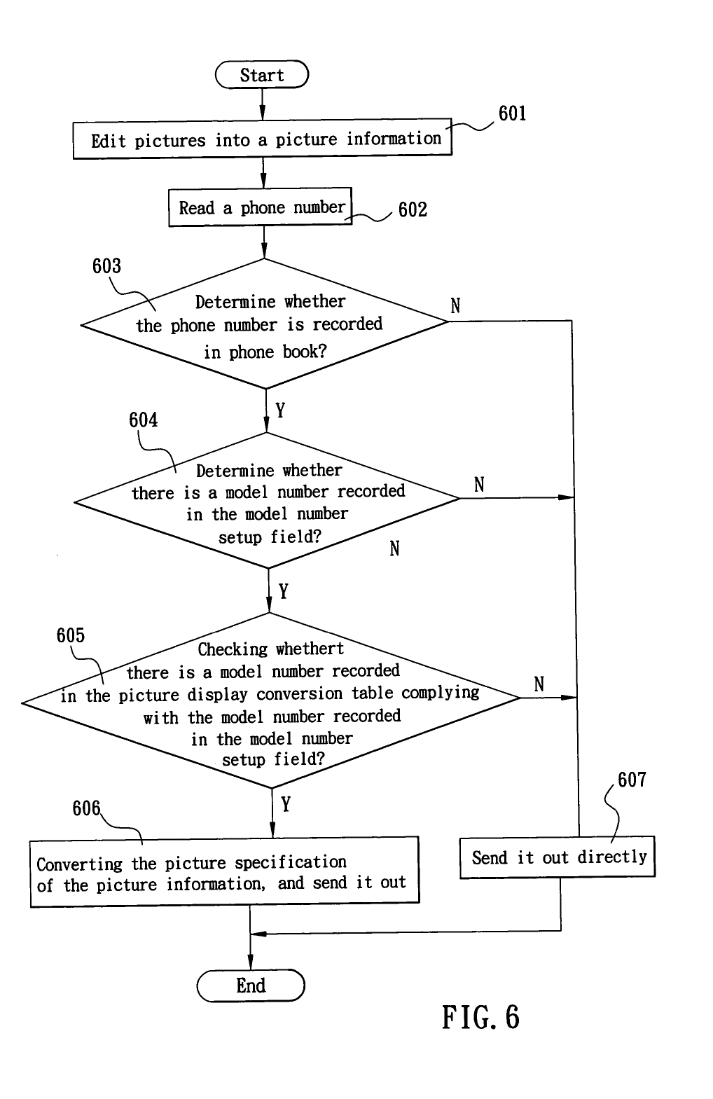

After the model number of the receiver's mobile telecommunication device being saved in the phone book 12, and the model numbers and the corresponding picture specifications in the picture display conversion table are correctly added or modified, the mobile telecommunication device is able to transmit a picture information to different models of mobile telecommunication device 1 according to the following steps, as referring to FIG. 6:

(601) Use the multimedia messaging service 13 to edit the pictures going to be sent into a picture information.

(602) Use the picture specification conversion program 10 to read a receiver's telephone number being inputted.

(603) Determine whether the receiver's telephone number is recorded in the phone book 12; if yes, go to Step (604); if no, go to Step (607).

(604) Determine whether there is a model number recorded in the model number setup field 121 of the number record 120 of the phone book 12; if yes, go to Step (605); if no, go to Step (607).

(605) Check whether there is a model number recorded in the picture display conversion table 101 complying with the model number recorded in the model number setup field 121; if yes go to Step (606); if no, go to Step (607).

(606) Convert the specification of the picture information into a picture specification recorded in the picture display conversion table 101 corresponding to the model number of the receiver's mobile telecommunication device, and sends the converted picture information out.

(607) Directly sends the picture information out.

Therefore, when the mobile telecommunication device 1 sends the picture information, the mobile telecommunication device 1 can change the size of the picture of the picture information automatically, so that the receiver's mobile telecommunication device can display a picture of the size complying with the picture display specification of the receiver's mobile telecommunication device. The present invention can overcome the shortcomings of traditional handset of being unable to display the picture in full or having a dark edge between the picture and the display screen.

While the invention has been described by means of specific embodiments, numerous modifications and variations could be made thereto by those skilled in the art without departing from the scope and spirit of the invention set forth in the claims.

What is claimed is:

1. A method of transmitting pictures by mobile telecommunication device, wherein said mobile telecommunication device is installed with a picture specification conversion program including a picture display conversion table having a plurality of model number fields and a plurality of picture specification fields corresponding to said model number fields, each of said model number fields is inputted with a specific model number and each of said picture specification fields is inputted with a specific picture specification corresponding to said model number, and a model number setup field is added into each number record of a phone book of said mobile telecommunication device for inputting a model number of a receiver's mobile telecommunication device or selecting the same from said picture display conversion table, such that when said mobile telecommunication device is going to transmit a picture information to a receiver's mobile telecommunication device, said mobile telecommunication device uses said picture conversion program to proceed with the steps of:
obtaining said model number of said receiver's mobile telecommunication device from said model number setup field according to said telephone number of said receiver's mobile telecommunication device being inputted;
using said model number to obtain the corresponding picture specification of a display screen of said receiver's mobile telecommunication device from said picture display conversion table;
converting said specification of said picture information being sent into a picture specification of said display screen of said receiver's mobile telecommunication device; and
sending said converted picture information out.

2. The method of claim 1, wherein said mobile telecommunication device is one selected from the collection of a handset and a personal digital assistant.

3. The method of claim 1, wherein said mobile telecommunication device further comprises an image capturer capable of obtaining a picture or being coupled to an electronic device for downloading a picture

4. The method of claim 1, wherein said mobile telecommunication device further comprises a multimedia messaging service for editing the picture into a picture information.

5. The method of claim 1, wherein the content of the phone book of the mobile telecommunication device is edited according to the steps of:
starting the mobile telecommunication device and opening the phone book;
editing a number record in the phone book for adding or modifying the data relating to a receiver's name and telephone number;
inputting the data relating to the receiver into the corresponding field of the number record;
inputting a model number of the receiver's mobile telecommunication device into the model number setup field of the number record;
saving the newly added or modified number record in the phone book.

6. The method of claim 1, wherein the content of the picture display conversion table of the mobile telecommunication device is edited according to the steps of:
starting the mobile telecommunication device;
opening the picture display conversion table;
editing the picture display conversion table for adding or modifying the model numbers of different mobile telecommunication devices;
editing the picture display conversion table for adding or modifying the picture specifications corresponding to the model numbers of different mobile telecommunication devices;
saving the newly added or modified model numbers and picture specifications of the different mobile telecommunication devices in the picture display conversion table.

7. The method of claim 1, wherein the mobile telecommunication device send a picture according to the steps of:
using the multimedia messaging service to edit the pictures going to be sent into a picture information;
using the picture specification conversion program to read a receiver's telephone number being inputted;
determining whether the receiver's telephone number is recorded in the phone book; if yes, go to the next step;
determining whether there is a model number recorded in the model number setup field of the number record of the phone book; if yes, go to the next step;
checking whether there is a model number recorded in the picture display conversion table complying with the model number recorded in the model number setup field; if yes go to next step;
converting the specification of the picture information into a picture specification recorded in the picture display conversion table corresponding to the model number of the receiver's mobile telecommunication device, and sends the converted picture information out.
